(19) United States
(12) Patent Application Publication
(10) Pub. No.: US 2007/0020502 A1
(43) Pub. Date: Jan. 25, 2007

(54) High temperature fuel cell system

(75) Inventors: Chung-kun Cho, Suwon-si (KR); Jan-gi Kim, Bucheon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/490,124

(22) Filed: Jul. 21, 2006

(30) Foreign Application Priority Data
Jul. 22, 2005 (KR) 2005-66992

(51) Int. Cl. H01M 2/08; H01M 8/02; H01M 8/12; B05D 5/12

(52) U.S. Cl. 429/35; 429/32; 429/36; 427/115

(57) ABSTRACT

A high temperature fuel cell system includes upper and lower sheet gaskets including inner portions respectively covering an extending portion of the electrolyte membrane and outer portions combined with each other, wherein the extending portion of the electrolyte membrane is exposed from the electrodes, rubber gaskets that are disposed on the outer portions of the sheet gaskets seal a space between the conductive plates and the sheet gaskets, and an adhesive seals the outer portions of the lower sheet gasket and upper sheet gasket, and wherein ends of the inner portions of the upper and lower sheet gaskets are respectively disposed between edges of the electrodes and the electrolyte membrane.

### CROSS-REFERENCE TO RELATED APPLICATION

This application claims the benefit of Korean Patent Application No. 2005-66992, filed on Jul. 22, 2005, in the Korean Intellectual Property Office, the disclosure of which is incorporated herein in its entirety by reference.

### BACKGROUND OF THE INVENTION

1. Field of the Invention

Aspects of the invention relate to a fuel cell system used at a high temperature, and more particularly, to a fuel cell system using phosphoric acid in a polymer electrolyte membrane as a hydrogen conductive material.

2. Description of the Related Art

A group of fuel cells form an energy generating system in which energy of a chemical reaction between oxygen and hydrogen contained in a hydrocarbon-based material, such as methanol, ethanol, or natural gas, is directly converted into electrical energy. Fuel cells can be categorized into phosphoric acid type fuel cells, molten carbonate type fuel cells, solid oxide type fuel cells, polymer electrolyte membrane fuel cells (PEMFC), alkali type fuel cells, and the like according to the electrolyte that is used. These fuel cells operate based on the same principle, but have different fuels, different operating temperatures, different catalysts, different electrolytes, etc.

A PEMFC typically has better energy output properties, a lower operating temperature, a quicker initial operation, and a quicker response than other fuel cells. In view of these advantages, PEMFCs typically have a wide range of applications, including portable power sources for cars, discrete power sources for homes or public buildings, and small power sources for electronic devices.

Conventionally, a PEMFC includes a polymer electrolyte membrane composed of a polymer electrolyte, such as a perfluorosulfonic acid polymer, for example, NAFION™. In this regard, it is noteworthy that a polymer electrolyte membrane can attain a high ionic conductivity through the impregnation of a proper, or suitable, amount of water.

In order to prevent dryness of the polymer electrolyte membrane of the PEMFC, the conventional PEMFC typically operates at 100° C. or less, for example, about 80° C. However, such a low temperature of 100° C. or less can result in the following problems. A hydrogen-rich gas, which is a main fuel for a PEMFC, can be obtained by reforming an organic fuel, such as a natural gas or methanol. However, the hydrogen-rich gas contains CO as well as CO₂ as a by-product. The CO can poison catalysts contained in a cathode and an anode. When a catalyst is poisoned with CO, its electrochemical activity can decrease significantly, and, thus, the operating efficiency and lifetime of the PEMFC can decrease significantly. In particular, it is noteworthy that the amount of poisoning of the catalyst typically increases as the operating temperature of the PEMFC is decreased.

When the operating temperature of the PEMFC is increased to about 130° C. or higher, the poisoning of the catalyst with CO can be prevented and the water management of the PEMFC can be easily controlled. As a result, a fuel reformer can be miniaturized and a cooling device can be simplified, and, thus, the energy generating system of a PEMFC can be miniaturized. However, the conventional electrolyte membrane, as for example, a polymer electrolyte, such as the perfluorosulfonic acid polymer, can experience a significant drop in performance due to evaporation of moisture at a high temperature.

Electrolyte membranes used in high temperature fuel cells typically use a strong acid, such as phosphoric acid or sulfuric acid, as a hydrogen ion conductive material instead of water. Accordingly, a polymer membrane soaked with a strong acid, such as phosphoric acid or sulfuric acid, is used. The membrane soaked with phosphoric acid is disposed between an anode electrode and a cathode electrode to form a membrane electrode assembly (MEA), and then a plurality of MEAs are stacked on a conductive plate to form a fuel cell stack. Hydrogen gas and air, which are used as a fuel, are respectively supplied to the anode electrode and the cathode electrode to generate electricity through chemical reactions. It is important to prevent, or minimize, the supplied fuel from moving through the membrane or along the sides of MEA to other electrodes without reacting with the corresponding catalyst. When the fuel does not react with the corresponding catalyst and moves to the opposite electrode, the fuel efficiency can decrease and the power density can also decrease because of the reduction in voltage.

The fuel can be prevented from moving through the membrane by forming a fine membrane structure, and the moving of the fuel along the sides of the MEA can be prevented by sealing the MEA using a gasket. U.S. Pat. No. 6,720,103 discloses fuel cells having sheet gaskets and rubber gaskets. However, since a membrane soaked with phosphoric acid is a thin film and slippery, and, in particular, shrinks according to the environment thereof, the membrane disclosed in U.S. Pat. No. 6,720,103 can separate from the sheet gaskets. Therefore, the sealing by the sheet gaskets is not necessarily reliable.

### SUMMARY OF THE INVENTION

Several aspects and example embodiments of the invention provide a high temperature fuel cell system that has improved sealing properties in consideration of the shrinkage and expansion of membranes therein.

According to an aspect, among aspects, of the invention, there is provided a high temperature fuel cell system that includes a plurality of membrane electrode assemblies (MEAs) having an anode electrode and a cathode electrode disposed on-respective sides of an electrolyte membrane, a plurality of conductive plates respectively contacting the electrodes, and the electrolyte membrane having phosphoric acid as a hydrogen conductive material, the high temperature fuel cell system including: upper and lower sheet gaskets including respective inner portions covering an extending portion of the electrolyte membrane and outer portions combined with each other, wherein the extending portion of the electrolyte membrane is exposed from the electrodes; rubber gaskets are disposed on the outer portions of the sheet gaskets to seal a space between the conductive plates and the sheet gaskets; and an adhesive seals the outer portions of the lower sheet gasket and upper sheet gasket, and wherein ends of the inner portions of the upper and lower sheet gaskets are respectively disposed between edges of the electrodes and the electrolyte membrane.

The sheet gaskets can be formed of a heat resistive polymer having a glass transition temperature greater than 130° C. and a thermal decomposition temperature greater than 200° C. The sheet gasket can be made of material selected from the group consisting of polyimide, polybenzimidazole, poly(amideimide), and poly(arylene ether phosphine) oxide, or other suitable material or composition.

The adhesive can be a heat resistive adhesive formed of a resin selected from the group consisting of a silicon-based resin, a fluorine-based resin, and an amide-based resin, or other suitable heat resistive adhesive. The rubber gaskets can be formed of a fluorine-based resin, or other suitable material or composition.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a unit cell and a plurality of unit cells of a high temperature fuel cell according to an embodiment, and aspects of the invention; and

FIGS. 2, 3 and 4 are plan views illustrating a sheet gasket and an electrolyte membrane in a unit cell and a method of combining a sheet gasket and an electrolyte membrane in a unit cell according to an embodiment and aspects of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

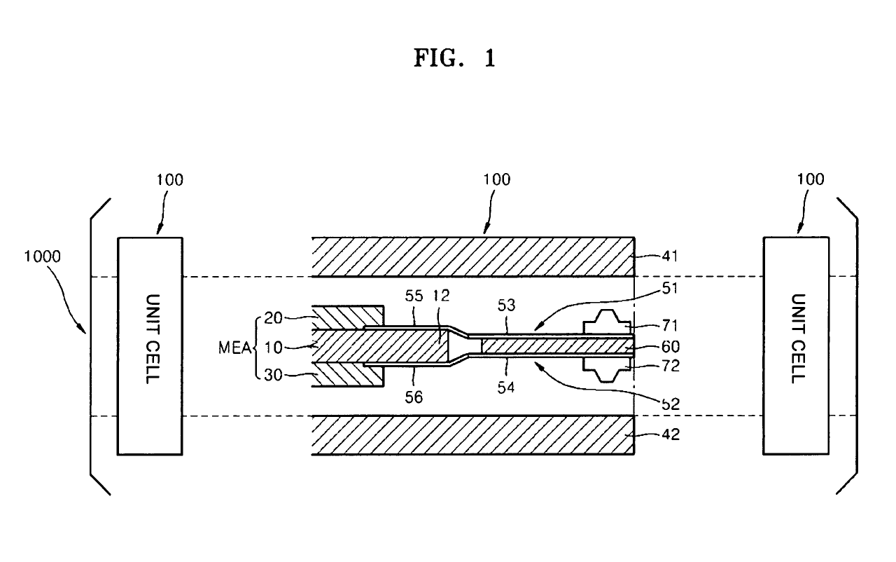

FIG. 1 is a cross-sectional view of a unit cell 100 and a plurality of unit cells 100, the plurality of unit cells 100 being indicated by the two block unit cells 100, the cross-sectional unit cell 100 and by the dashed lines indicating stacked unit cells 100, of a high temperature fuel cell 1000 according to an embodiment and aspects of the invention. As indicated in FIG. 1, by way of example, tens to hundreds of the unit cells 100 can be stacked in the high temperature fuel cell 1000. Each unit cell 100 of the high temperature fuel cell 1000 includes a membrane electrode assembly (MEA) which includes an anode electrode 20 and a cathode electrode 30 respectively disposed on respective sides of an electrolyte membrane 10. Conductive plates 41 and 42 are disposed on, over or in communication with, the anode electrode 20 and the cathode electrode 30, respectively. A fuel channel (not illustrated) through which a fuel, that is, hydrogen gas or air as an oxidizer, is supplied to the corresponding anode electrode 20 and the cathode electrode 30 is respectively formed in each of the conductive plates 41 and 42.

Since the electrolyte membrane 10 is used at high temperatures, as for example, 130° C., the electrolyte membrane 10 typically includes an acid as a hydrogen conductive material instead of water. The electrolyte membrane 10 can shrink due to the high temperature, and the length of the electrolyte membrane 10 can shrink by about 1 to 2%. The electrolyte membrane 10 includes an extending portion 12 exposed from the anode electrode 20 and the cathode electrode 30.

The fuel cell system 1000 includes in the unit cell 100 sheet gaskets 51 and 52 and secondarily sealing gaskets 71 and 72 to seal the fuel in the unit cell 100. The sheet gaskets 51 and 52 are an upper sheet gasket 51 and a lower sheet gasket 52. The sealing gaskets 71 and 71 being rubber, a rubber type material or composition, such as a fluorine-based resin, or other suitable material or composition, for example. The sheet gaskets 51 and 52 respectively include outer portions 53 and 54 connected by an adhesive 60 and inner portions 55 and 56 contacting the sides of the electrolyte membrane 10. Ends of the inner portions 55 and 56 can be respectively arranged between the electrolyte membrane 10 and edges of the corresponding anode electrode 20 and the cathode electrode 30. The arrangement of the inner portions 55 and 56, as described, promotes maintaining a good seal between the anode electrode 20 and the cathode electrode 30 and the gaskets 51 and 52 when the electrolyte membrane 10 shrinks.

Since the upper and lower sheet gaskets 51 and 52 are exposed to a relatively strong acid, such as phosphoric acid, the upper and lower sheet gaskets 51 and 52 are typically formed of a high acid-resistant material. The upper and lower sheet gaskets 51 and 52 typically have thicknesses of about 1 μm to about 300 μm, for example. When the sheet gaskets 51 and 52 have thicknesses of less than 1 μm, the treatment for the sheet gaskets 51 and 52 can be difficult. When the upper and lower sheet gaskets 51 and 52 have thicknesses of greater than 300 μm, the sealing between the anode electrode 20 and cathode electrode 30 and the electrolyte membrane 10 can deteriorate. In addition, the glass transition temperatures of the sheet gaskets 51 and 52 are typically greater than 130° C., for example. If the glass transition temperatures of the sheet gaskets 51 and 52 are less than 130° C., the sheet gaskets 51 and 52 can gradually deform and the sealing can deteriorate.

Since the inner portions 55 and 56 of the sheet gaskets 51 and 52 contact the electrolyte membrane 10, the sheet gaskets 51 and 52 typically have a high acid-resistance. In addition, since the sheet gaskets 51 and 52 are typically exposed to high temperatures for relatively long durations, the thermal decomposition temperature of the sheet gaskets 51 and 52 can be higher than 200° C. The thermal decomposition temperature of the sheet gaskets 51 and 52 is generally higher than, for example, 400° C. The sheet gaskets 51 and 52 can be formed of, for example, polyimide, polybenzimidazole, poly(amideimide), or poly(arylene ether phosphine oxide), or other suitable material or composition. The sheet gaskets 51 and 52 are typically formed of a heat resistive polymer having a glass transition temperature greater than or equal to 130° C. and a thermal decomposition temperature greater than or equal to 200° C.

The adhesive 60 fixes the upper and lower sheet gaskets 51 and 52. By way of example, the adhesive 60 can fix the upper and lower sheet gaskets 51 and 52 at room temperature, can be hardened by high temperature treating after attaching to the upper and lower sheet gaskets 51 and 52 at room temperature, and can be melted at high temperature to be pressed for attachment to the upper and lower sheet gaskets 51 and 52. The high temperature treating and melting-pressing of the adhesive 60 to fix the upper and lower sheet gaskets 51 and 52 can be complicated, and the water in the acid can be volatized. Accordingly, in an embodiment and according to aspects of the invention, the adhesive 60 is typically attached to the upper and lower sheet gaskets 51 and 52 at room temperature.

In addition, according to aspects of the invention, the adhesive 60 typically has a high thermal decomposition temperature because the adhesive 60 is typically exposed to a high temperature for a relatively long duration. When compared with the sealing using hot pressing, the adhesiveness of the adhesive 60 processed at room temperature can be low in adhesion. To compensate for this low adhesion, the sealing gaskets 71 and 72 can be disposed on the upper and lower sheet gaskets 51 and 52 to enhance sealing. The adhesive 60 can be a heat resistant adhesive formed with, for example, a silicon-based, fluorine-based, or amide-based resin, which can maintain adhesiveness at high temperatures, or other suitable material or composition. The adhesive 60 can be adhered to the sheet gaskets 51 and 52 at room temperature, by way of example, according to aspects of the invention.

The rubber gaskets 71 and 72 can be formed of a material having good heat resistance and chemical stability, for example, a silicon-based or a fluorine-based material, or other suitable material or composition. The rubber gaskets 71 and 72 seal to form a secondary barrier to the leakage of the fuel in the unit cell 100.

The electrolyte membrane 10 typically is a relatively thin film that is soaked with phosphoric acid, and, thus, the mechanical strength of the electrolyte membrane 10 is relatively very low. In addition, since ends of the sheet gaskets 51 and 52 are respectively inserted between the anode electrode 20 and the cathode electrode 30 and electrolyte membrane 10, a conventional method, for example, such as the binding of the sheet gaskets 51 and 52 respectively to both surfaces of the electrolyte membrane 10, typically cannot be employed.

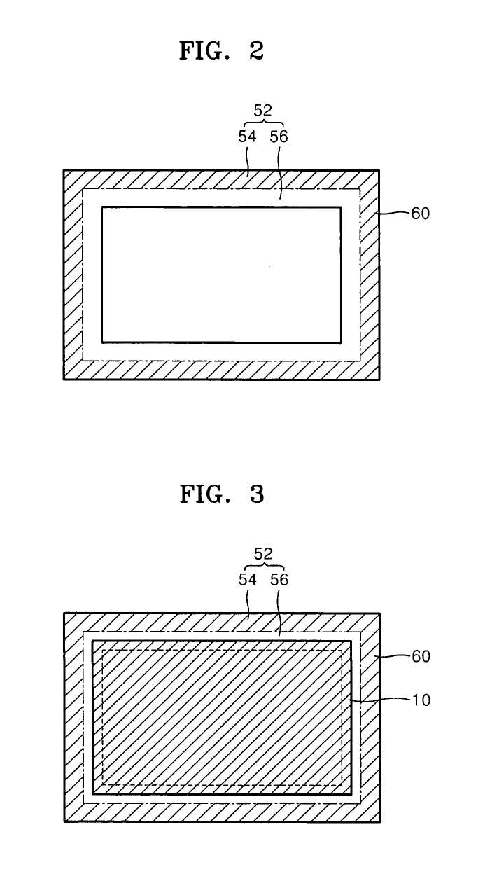

FIGS. 2, 3 and 4 are plan views illustrating the sheet gaskets 51 and 52 and the electrolyte membrane 10 in the unit cell 100 and a method of combining the sheet gaskets 51 and 52 and the electrolyte membrane 10 in the unit cell 100, according to an embodiment and aspects of the invention. Referring to FIG. 2, the adhesive 60 is deposited on the outer portion 54 of the lower sheet gasket 52 by a suitable operation. By way of example, the adhesive 60 can be deposited on a polyethylene terephthalate (PET) film (not illustrated), and the PET film can be aligned on the lower sheet gasket 52 and detached from the sheet gasket 52, thereby transferring the adhesive 60 disposed on the PET film to the sheet gasket 52.

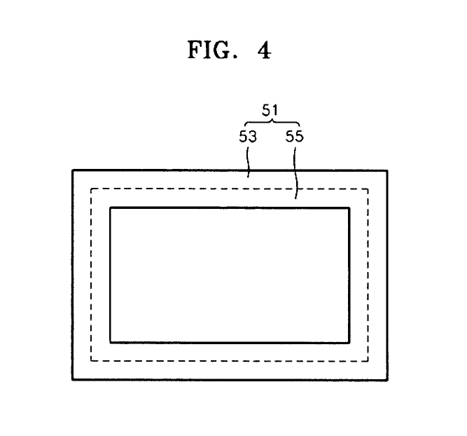

Referring to FIG. 3, the electrolyte membrane 10 is arranged on the inner portion 56 of the lower sheet gasket 52. The electrolyte membrane 10 does not contact the adhesive 60 disposed on the outer portion 54. Next, continuing with reference to FIG. 4, the upper sheet gasket 51 is aligned with the lower sheet gasket 52 and the upper and lower sheet gaskets 51 and 52 are pressed so that the outer portions 53 and 54 of the upper and lower sheet gaskets 51 and 52 are attached together by the adhesive 60 at the room temperature. The electrolyte membrane 10 is disposed between the sheet gaskets 51 and 52.

The anode and cathode electrodes 20 and 30 are attached on the electrolyte membrane 10. The edges of the anode and cathode electrodes 20 and 30 can be disposed on inner ends of the inner portions 55 and 56 of the sheet gaskets 51 and 52. The ends of the sheet gaskets 51 and 52 are respectively inserted between the edges of the anode electrode 20 and the cathode electrode 30 and the electrolyte membrane 10. The sealing gaskets 71 and 72 and the conductive plates 41 and 42 can be combined to the MEA and sheet gaskets 51 and 52 in the unit cell 100 using conventional methods as known to those skilled in the art. Also, the above operations can all be performed at room temperature. As described, the high temperature fuel cell system according to aspects of the invention can maintain good sealing properties when the electrolyte membrane expands or shrinks.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A high temperature fuel cell system, comprising:
a plurality of membrane electrode assemblies (MEAs) having an anode electrode and a cathode electrode disposed on respective sides of an electrolyte membrane, the electrolyte membrane having phosphoric acid as a hydrogen conductive material;
a plurality of conductive plates respectively contacting the anode and cathode electrodes;
upper and lower sheet gaskets comprising respective inner portions covering an extending portion of the electrolyte membrane and outer portions combined with each other, wherein the extending portion of the electrolyte membrane is exposed from the anode and cathode electrodes;
rubber gaskets that are respectively disposed on the outer portions of the upper and lower sheet gaskets to seal a space between the conductive plates and the upper and lower sheet gaskets; and
an adhesive to seal the outer portions of the lower sheet gasket and upper sheet gasket,
wherein ends of the inner portions of the upper and lower sheet gaskets are respectively disposed between edges of the anode and cathode electrodes and the electrolyte membrane.

2. The high temperature fuel cell system of claim 1, wherein the upper and lower sheet gaskets comprise a heat resistive polymer having a glass transition temperature greater than or equal to 130° C. and a thermal decomposition temperature greater than or equal to 200° C.

3. The high temperature fuel cell system of claim 2, wherein the upper and lower sheet gaskets comprise a material selected from a group consisting of polyimide, polybenzimidazole, poly(amideimide), and poly(arylene ether phosphine) oxide.

4. The high temperature fuel cell system of claim 2, wherein a thickness of the upper and lower sheet gaskets ranges from about 1 μm to about 300 μm.

5. The high temperature fuel cell system of claim 1, wherein the adhesive comprises a heat resistive adhesive formed of a resin selected from the group consisting of a silicon-based resin, a fluorine-based resin, and an amide-based resin.

6. The high temperature fuel cell system of claim 1, wherein the rubber gaskets comprise a fluorine-based resin.

7. The high temperature fuel cell system of claim 6, wherein the adhesive comprises a heat resistive adhesive formed of a resin selected from the group consisting of a silicon-based resin, a fluorine-based resin, and an amide-based resin.

8. The high temperature fuel cell system of claim 7, wherein the upper and lower sheet gaskets comprise a heat resistive polymer having a glass transition temperature greater than or equal to 130° C. and a thermal decomposition temperature greater than or equal to 200° C.

9. The high temperature fuel cell system of claim 8, wherein the upper and lower sheet gaskets comprise a material selected from a group consisting of polyimide, polybenzimidazole, poly(amideimide), and poly(arylene ether phosphine) oxide.

10. The high temperature fuel cell system of claim 9, wherein a thickness of the upper and lower sheet gaskets ranges from about 1 μm to about 300 μm.

11. A high temperature fuel cell system, comprising:
a plurality of membrane electrode assemblies (MEAs) having an anode electrode and a cathode electrode disposed on respective sides of an electrolyte membrane, the electrolyte membrane comprising a hydrogen conductive material;
a plurality of conductive plates respectively communicating with the anode and cathode electrodes;
upper and lower sheet gaskets comprising respective inner portions covering an extending portion of the electrolyte membrane and outer portions combined with each other, wherein the extending portion of the electrolyte membrane is exposed from the anode and cathode electrodes;
sealing gaskets that are respectively disposed on the outer portions of the upper and lower sheet gaskets to seal a space between the conductive plates and the upper and lower sheet gaskets; and
an adhesive to seal the outer portions of the lower sheet gasket and upper sheet gasket,
wherein ends of the inner portions of the upper and lower sheet gaskets are respectively disposed between edges of the anode and cathode electrodes and the electrolyte membrane.

12. The high temperature fuel cell system of claim 11, wherein:
the adhesive comprises a heat resistive adhesive formed of a resin selected from the group consisting of a silicon-based resin, a fluorine-based resin, and an amide-based resin,
the upper and lower sheet gaskets comprise a heat resistive polymer having a glass transition temperature greater than or equal to 130° C. and a thermal decomposition temperature greater than or equal to 200° C.

13. The high temperature fuel cell system of claim 12, wherein the upper and lower sheet gaskets comprise a material selected from a group consisting of polyimide, polybenzimidazole, poly(amideimide), and poly(arylene ether phosphine) oxide.

14. The high temperature fuel cell system of claim 13, wherein a thickness of the upper and lower sheet gaskets ranges from about 1 μm to about 300 μm.

15. The high temperature fuel cell system of claim 14, wherein the sealing gaskets comprise rubber or a rubber type material or composition.

16. The high temperature fuel cell system of claim 12, wherein a thickness of the upper and lower sheet gaskets ranges from about 1 μm to about 300 μm.

17. A method of forming a unit cell of high temperature fuel cell system, comprising:
disposing an anode electrode and a cathode electrode on respective sides of an electrolyte membrane to provide a membrane electrode assembly (MEA);
disposing a plurality of conductive plates in respective communicating relation with the anode and cathode electrodes;
covering an extending portion of the electrolyte membrane with respective inner portions of upper and lower sheet gaskets and combining outer portions of the upper and lower sheet gaskets with each other, wherein the extending portion of the electrolyte membrane is exposed from the anode and cathode electrodes;
disposing sealing gaskets respectively on the outer portions of the upper and lower sheet gaskets to seal a space between the conductive plates and the upper and lower sheet gaskets; and
sealing the outer portions of the upper and lower sheet gaskets,
wherein ends of the inner portions of the upper and lower sheet gaskets are respectively disposed between edges of the anode and cathode electrodes and the electrolyte membrane.

18. The method of claim 17, further comprising:
providing a plurality of the unit cells; and
stacking the plurality of the unit cells to form the high temperature fuel cell system.

19. The method of claim 18, further comprising:
providing the electrolyte membrane to comprise a hydrogen conductive material.

20. The method of claim 19, wherein the providing the hydrogen conductive material comprises providing phosphoric acid as the hydrogen conductive material.

21. The method of claim 17, further comprising:
providing the electrolyte membrane to comprise a hydrogen conductive material.

22. The method of claim 21, wherein the providing the hydrogen conductive material comprises providing phosphoric acid as the hydrogen conductive material.

23. A method of forming a unit cell of high temperature fuel cell system, comprising:
covering an extending portion of an electrolyte membrane with respective inner portions of upper and lower sheet gaskets and combining outer portions of the upper and lower sheet gaskets with each other, wherein the extending portion of the electrolyte membrane is exposed from anode and cathode electrodes;
disposing ends of the inner portions of the upper and lower sheet gaskets respectively between edges of the anode and cathode electrodes and the electrolyte membrane; and
sealing the outer portions of the upper and lower sheet gaskets.

24. The method of claim 23, further comprising:
providing the electrolyte membrane to comprise a hydrogen conductive material.

25. The method of claim 23, wherein the providing the hydrogen conductive material comprises providing phosphoric acid as the hydrogen conductive material.
